(19) United States
(12) Patent Application Publication
(10) Pub. No.: US 2020/0209365 A1
(43) Pub. Date: Jul. 2, 2020

(54) LASER DATA CALIBRATION METHOD AND ROBOT USING THE SAME

(71) Applicant: Ubtech Robotics Corp Ltd, Shenzhen (CN)

(72) Inventors: Yongsheng Zhao, Shenzhen (CN); Youjun Xiong, Shenzhen (CN); Zhichao Liu, Shenzhen (CN); Jianxin Pang, Shenzhen (CN)

(21) Appl. No.: 16/396,693

(22) Filed: Apr. 28, 2019

(30) Foreign Application Priority Data
Dec. 29, 2018 (CN) 201811645449.8

(51) Int. Cl. G01S 7/497; G01S 7/48; G01S 17/10; G05D 1/02

(52) U.S. Cl. CPC G01S 7/497; G05D 1/0231; G01S 17/10; G01S 7/4808

(57) ABSTRACT

The present disclosure provides a laser data calibration method and robot using the same. The method includes: obtaining a pose of a movable device; determining a pose of the lidar based on the pose of the movable device and a transformation relationship between the movable device and the lidar: determining an instantaneous speed of the lidar based on the pose of the lidar at two adjacent time points; determining a delay time of an collection time of one frame of raw laser data obtained through the lidar by scanning for one round with respect to an collection time of a first raw laser data: and obtaining a calibration data of the raw laser data based on the instantaneous speed, tire delay time, and the raw laser data. Through the above-mentioned method, the calibration of the raw laser data can be realized.

### CROSS REFERENCE TO RELATED APPLICATION PROGRAMS

This application claims priority to Chinese Patent Application No. CN201811645449.8, filed Dec. 29, 2018, which is hereby incorporated by reference herein as if set forth in its entirety.

### BACKGROUND

### 1. Technical Field

The present disclosure relates to radar data calibration technology, and particularly to a laser data calibration method and robot using the same.

### 2. Description of Related Art

Except solid state lidars (i.e., laser radars), for single-line or multi-line lidars, the laser data of each line is actually obtained by a laser head capable of performing high-speed ranging through rotating the lidar itself to collect the distance data at 360 degrees, where the speed of rotating the lidar itself is generally 5-15 rounds per second.

In the case that a rotatable lidar is mounted on a movable device, when the movable device is moved, the ranging data collected by the lidar through rotating may have a deviation with respect to the ranging data collected when the movable device is kept static. If the moving speed or angular velocity of the movable device is small, the deviation will be small. However, if the moving speed or angular velocity of the movable device becomes larger, the deviation will be also increased, which results in the lower accuracy of the obtained ranging data. FIG. 1 is a schematic diagram of a scenario of a ranging method with errors according to the prior art. As shown in FIG. 1, the picture in the left is the actual scene, and the picture in the right is the scene obtained by the scanning of the lidar. Although the shapes of the two objectives O are the same, the orientations are not the same.

Therefore, it is necessary to provide a new method to solve the above-mentioned technical problems.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a schematic diagram of a scenario of a ranging method with errors according to the prior art.

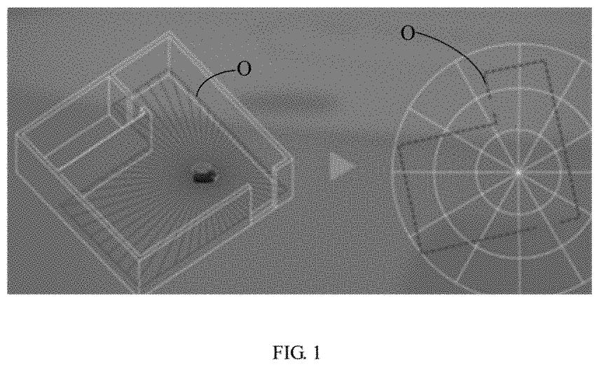

FIG. 2 is a flow chart of an embodiment of a laser data calibration method according to the present disclosure.

FIG. 3 is a schematic diagram of a triangular relationship constructed based on a pose of a single-line lidar.

FIG. 4 is a schematic block diagram of an embodiment of a laser data calibration apparatus according to the present disclosure.

FIG. 5 is a schematic block diagram of an embodiment of a robot according to the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

For the purpose of describing the technical solutions of the present disclosure, the following describes through specific embodiments.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “a,” “an,” and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

As used in the description and the appended claims, the term “if” may be interpretal as “when” or “once” or “in response to determining” or “in response to detecting” according to the context. Similarly, the phrase “if determined” or “if [the, described condition or event] is detected” may be interpreted as “once determining” or “in response to determining” or “on detection of [the described condition or event]” or “in response to detecting [the described condition or event]”.

In specific implementations, in the present disclosure, a robot in the embodiments includes but is not limited to an auto-driving car, a self-driving car, an auto-driving logistics trolley, a sweeper, a service robot, an automated guided vehicle, an inspection robot.

In the following descriptions, robots each including a display and a touch sensitive surface is described. However, it should be understood that, a robot may further include one or more other physical user interface devices such as a physical keyboard, mouse, and/or joystick.

The robot supports various applications such as one or more of: a drawing application, a presentation application a word processing application, website creation application, a disk burning application, a spreadsheet application, a game application, a phone applications, a video conferencing application, an email application, an instant messaging application, an exercise support application, a photo management application, a digital camera application, a digital video camera application, a web browsing application, a digital music player application, and a digital video player application.

Various applications that can be executed on the robot can use at least one common physical user interface device such as a touch sensitive surface. One or more functions of the touch sensitive surface and corresponding information displayed on the robot can be adjusted and/or changed between applications and/or within a corresponding application. In this way, the common physical architecture of the robot (e.g., a touch-sensitive surface) can support various applications with a user interface that is intuitive and transparent to the user.

In addition, in the present disclosure, the terms “first”, “second”, and the like in the descriptions are only used for distinguishing, and cannot be understood as indicating or implying relative importance.

### Embodiment 1

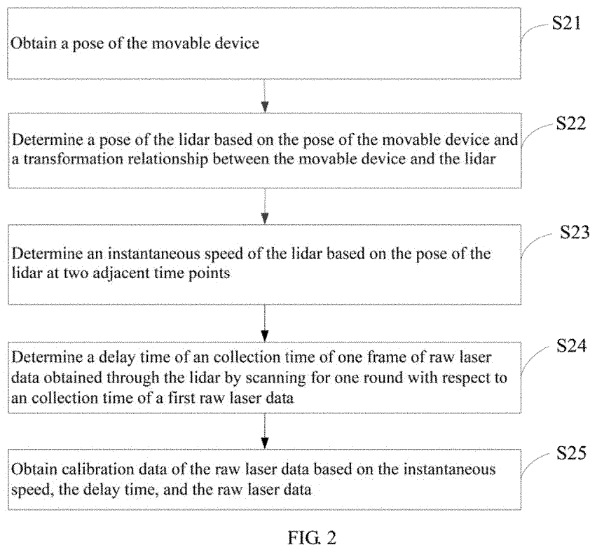

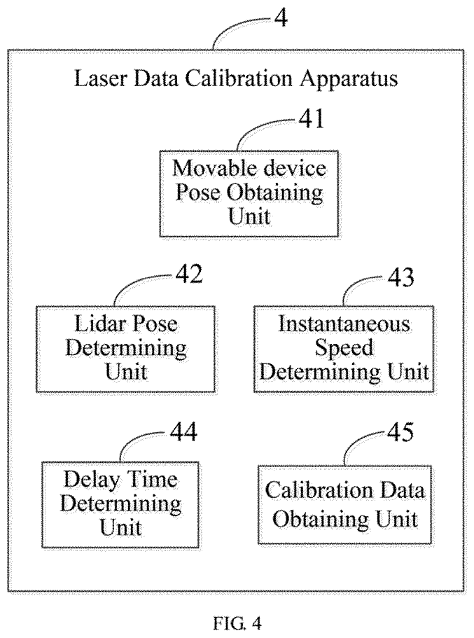

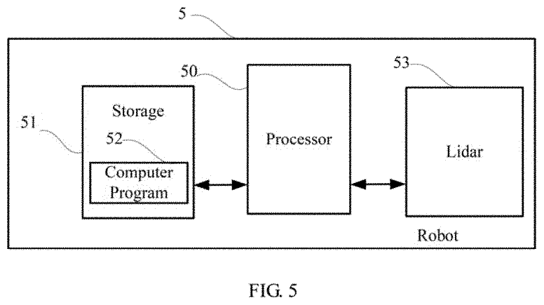

FIG. 2 is a flow chart of an embodiment of a laser data calibration method according to the present disclosure. In this embodiment, a laser data calibration method is provided. The method is a computer-implemented method executable for a processor, which may be implemented through and applied to a laser data calibration apparatus as shown in FIG. 4 or a robot as shown in FIG. 5 that has the processor and a lidar (i.e., a laser radar), or through a storage medium. As show in FIG. 2, the method includes the following steps.

S21: obtaining a pose of the movable device.

In this embodiment, the movable device is a robot. The movable device is installed with the lidar which collects distance information and angle information of the external environment by rotating itself.

In this embodiment, the pose of the movable device refers to the pose of the movable device which is projected on a horizontal plane, which can be obtained periodically, or obtained after a time interval.

S22: determining a pose of the lidar based on the pose of the movable device and a transformation relationship between the movable device and the lidar, where the transformation relationship between the movable device and the lidar determined based on an installation position of the lidar on the movable device.

S23: determining an instantaneous speed of the lidar based on the pose of the lidar at two adjacent time points.

In this embodiment, since the lidar can be rotated for 5-15 rounds in one second, it can be considered that the lidar is moved at a uniform speed when obtaining all raw laser data at the same frame (one frame of the raw laser data is obtained by the lidar through scanning for one round) and will not produce a large error, hence it is possible to determine the instantaneous speed of the lidar through the pose of the lidar at the time points of obtaining two adjacent raw laser data.

S24: determining a delay time of an collection time of one frame of raw laser data obtained through the lidar by scanning for one round with respect to an collection time of a first raw laser data.

In this embodiment, the first raw laser data refers to the first raw laser data in the same frame with the collected raw laser data.

For a single-line lidar, each frame of raw laser data is a series a ranging points that are scanned in a horizontal direction at 360 degrees, which includes corresponding values of the distance information and angle information. The format of the raw laser data is generally a form of polar coordinate such as {[distance1, theta1], [distance2, theta2], [distance3, theta3]. . . }.

S25: obtaining a calibration data of the raw laser data based on the instantaneous speed, the delay time, and the raw laser data.

In this embodiment, the calibration data of the raw laser data collected by the lidar is obtained based on the instantaneous speed of the lidar, the delay time of the, collection time of the raw laser data with respect to the collection time of the first raw laser data in the same frame, and the raw laser data, that is, the positions of all the raw laser data obtained in the same frame are projected to the position of the first raw laser data in the same frame, thereby realizing the calibration of the raw laser data.

In one embodiment, if the lidar is a single-line lidar, step S22 the may include:

A1: determining a horizontal position difference {dx, dy, dth} of the lidar with respect to the movable device based on the installation position of the lidar on the movable device. For instance, the horizontal position difference between the lidar and the movable device is determined based on the installation position of the lidar on the movable device, and the transformation relationship if from the pose of the movable device to the pose of the lidar is determined.

A2 determining the pose of the lidar by the following formula:

lidarPose.x=devPose.x+tf.dx;

lidarPose.y=devPose.y+tf.dy:

lidarPose.theta=devPose.theta+tf.dth;

where, lidarPose.x, lidarPose.y, and lidarPose.theta respectively indicates the pose of the lidar of different components on a horizontal plane; devPose.x, devPose. and devPose.theta respectively indicates the pose of different components of the movable device on the horizontal plane, and tf indicates the transformation relationship between the pose of the movable device and the pose of the lidar.

In this embodiment, devPose.x, devPose.y and devPose.theta compose the pose obtained in step S21.

In one embodiment, if the lidar is a single-line lidar, and the instantaneous speed V1 of the lidar includes three components of V1.vx, V1.vy, and V1.vth, then step S23 may include:

determining three components V1.vx, V1.vy, and V1.vth included in the instantaneous speed V1 by the following formulas:

V1.vx=(lidarPose2.x-lidarPose1,x)/(t2−t1);

V1.vy=(lidarPose2.y-lidarPose1.y)/(t2−t1); and

V1.vth=(lidarPose2.theta-lidarPose1.theta)/(t2−t1);

where, lidarPose2x, lidarPose2,y, and lidarPose2.theta respectively indicates the pose of the lidar of different components on a horizontal plane at the time point t2, lidarPose1.x, lidarPose1.y, and lidarPose1.theta respectively indicates the pose of the lidar of different components on a horizontal plane at the dime point t1, and the time point t1 and the time point t2 are two adjacent time points.

In this embodiment, the instantaneous speed for the lidar to collect all the raw laser data in the same frame is the same, for instance, when the instantaneous speed of the lidar is calculated by collecting the first raw laser data and collecting the second raw laser data, the calculated instantameous speed may be taken as the instantaneous speed for the lidar to collect all the raw laser data in the same frame.

In one embodiment, if the lidar is a single-line lidar step S25 may include:

calculating the delay time of the collection time of the raw laser data of point pN with respect to the collection time of the first raw laser data (i.e., the raw laser data of the first point p1) in the same frame as the raw laser data by the following formula:

delayTn1=T*thetaN/360 °;

where, delayTn1 is the delay time, T is the time of the lidar to scan for one round, and thetaN is an angle corresponding to the ra laser data of point pN (It should be noted that, when the lidar scans for one round, one frame of the raw laser data will be obtained);

calculating a pose difference of pose poseN with respect to pose pose1 by the following formula:

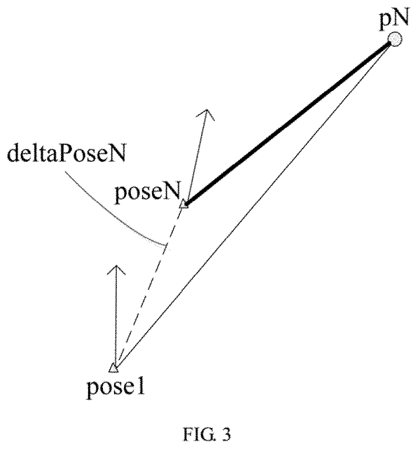

deltaPoseN=poseN−pose1=V1*delayTn1;

where, deltaPoseN is the pose difference (see FIG. 3), poseN is the pose of the lidar when collecting the raw laser data of point pN, and pose1 is the pose of the lidar when collecting the raw laser data of point p1;

transforming the raw laser data (distanceN, thetaN) of point pN from a polar coordinate to a Cartesian coordinate by the following formulas:

pN.x=distanceN* cos(thetaN); and

pN.y=distanceN* sin(thetaN);

transforming the Cartesian coordinate of point pN from a coordinate system of poseN to to coordinate system of pose1 by the following formulas:

pN′.x=deltaPoseN.x+cos(deltaPoseN.theta)*pN.x−sin(deltaPoseN.theta)*pN.y; and

pN′.y=deltaPoseN.y+sin(deltaPoseN.theta)*pN.x+cos(deltaPoseN.theta)*pN.y; and

transforming the Cartesian coordinate in the coordinate system of pose1 to a polar coordinate by the following formulas:

pN′.distance=; and

pN′.theta=tan(pN′.x).

In this embodiment, by the above-mentioned method, the calibrated of the distance information and angle information in the raw laser data which are obtained by the single-line lidar can be realized, and then obtain the calibrated distance information and angle information.

In one embodiment, if the lidar is a multi-line lidar, step S22 may include:

B1: determining a corresponding transformation matrix based on the transformation relationship between the movable device and the lidar; and

B2: taking, a product of the pose of the movable device and the transformation matrix as the pose of the lidar.

Since the points obtained by the multi-line lidar are three-dimensional, the motion of the movable device is also three-dimensional, hence the positional change relationship of the multi-line lidar with respect to the movable device is represented by a transformation matrix.

In one embodiment, if the lidar is a multi-line lidar, the instantaneous speed is represented by an instantaneous speed matrix, and step S23 may include:

C1: obtaining a first difference between the pose of the lidar corresponding to the time point t2 and the pose of the lidar corresponding to the time point t1, wherein the time point t1 and the time point t2 are adjacent time points;

C2; obtaining a second difference between the time point t2 and the time point t1; and

C3: taking a quotient of the first difference and the second difference as the instantaneous speed matrix of the lidar.

In one embodiment, if the lidar is a multi-line lidar, step S25 may include:

D1: transforming the raw laser data from a form of polar coordinate to a form of Cartesian coordinate, where the raw laser data includes distance information and angle information, that is, the raw laser data is expressed in the form of polar coordinate.

D2: obtaining the calibration data of the raw laser data transformed to the form of Cartesian coordinate her the following formulas:

pM′=pM*(V2*delayTn2)⁻¹, where “−1” indicates the inverse of V2*delay/Tn2; and

delayTn2=T*thetaM/360°;

where, pM is the Mth raw laser data has been transformed to the form of Cartesian coordinate corresponding to the Mth point, pM′ is the calibration data of the Mth raw laser data has been transformed to the form of Cartesian coordinate, V2 is the instantaneous speed matrix, delay/Tn2 is the delay time of the collection time of the raw laser data of the Mth point with respect to the collection time of the first raw laser data, T is the time of the lidar to scan for one round, and thetaM is an angle corresponding to the raw laser data of the Mth point.

In this embodiment, the obtained calibration data is represented in the form of a Cartesian coordinate.

In one embodiment, the calibration data in a form of the Cartesian coordinate can be converted to a form of a polar coordinate.

### Embodiment 2

FIG. 4 is a schematic block diagram of an embodiment of a laser data calibration apparatus according to the present disclosure. In this embodiment, a laser data calibration apparatus for a robot (see FIG. 5) having a lidar is provided. For convenience of description, only related parts are shown. As shown in FIG. 4, a laser data calibration, apparatus 4 includes a movable device pose obtaining unit 41, a lidar pose determining unit 42, an instantaneous speed determining unit 43, a delay time determining unit 44, and a calibration data obtaining unit 45.

The movable device pose obtaining unit 41 is configured to obtain a pose of the movable device.

The lidar pose determining unit 42 is configured to determine a pose of the lidar based on the pose of the movable device and a transformation relationship between the movable device and the lidar, where, the transformation relationship between the movable device and the lidar is determined based on an installation position of the lidar on the movable device.

The instantaneous speed determining unit 43 is configured to determine an instantaneous speed of the lidar based on the pose of the lidar at two adjacent time points.

The delay time determining unit 44 is configured to determine a delay time of an collection time of one frame of raw laser data obtained through the lidar by scanning for one round with respect to an collection time of a first raw laser data.

The calibration data obtaining unit 45 is configured to obtain a calibration data of the raw laser data based on the instantaneous speed, the delay time, and the raw laser data.

In this embodiment, the movable device pose obtaining unit 41, the lidar pose determining unit 42, the instantaneous speed determining unit 43, the delay time determining unit 44, and the calibration data obtaining unit 45 are implemented in the form of software, which can be computer program(s) stored in a memory of the laser data calibration apparatus 4 and executable on a processor of the laser data calibration apparatus 4. In other embodiments, the movable device pose obtaining unit 41, the lidar pose determining unit 42, the instantaneous speed determining unit 43, the delay time determining unit 44, and the calibration data obtaining unit 45 may be implemented in the form of hardware (e.g., a circuit of the laser data calibration apparatus 4, which is coupled to the processor of the laser data, calibration apparatus 4) or a combination of hardware and software (e.g., a circuit with a single chip microcomputer).

In this embodiment, the calibratim data of the raw laser data collected by the lidar is obtained based on the instantaneous speed of the lidar, the delay time of the collection time of the raw laser data with respect to the collection time of the first raw laser data in the same frame, and the raw laser data, that is, the positions of all the raw laser data obtained in the same frame are projected to the position of the first raw laser data in the same frame, thereby realizing the calibration of the raw laser data.

In one embodiment, if the lidar is a single-line lidar, the lidar pose determining unit 42 may include:

a horizontal position difference determining module configured to determine a horizontal position difference {dx, dy dth} of the lidar with respect to the movable device based on the installation position of the lidar on the movable device; and

a single-line lidar pose determining module configured to determine the pose of the lidar by the following formula:

lidarPose.x=devPose.x+tf.dx;

lidarPose.y=devPose.y +tf.dy;

lidarPose.theta=devPose.theta+tf.dth;

where, lidarPose.x, lidarPose.y, and lidarPose.theta respectively indicates the pose of the lidar of different components on a horizontal plane; devPose.x. devPose.y, and devPose.theta respectively indicates the pose of different components of the movable device on the horizontal plane, and tf indicates the transformation relationship between the movable device and the lidar.

In one embodiment, if the lidar is a single-line lidar, the istantaneous speed V1 of the lidar includes three components of V1.vx, V1.vy, and V1.vtt, the instantaneous speed determining, unit 43 is configured to:

determine three components V1.vx, V1.vy, and V1.vth included in the instantaneous speed V1 by the following formulas;

V1.vx=(lidarPose2.x−lidarPose1.x)/(t2−t1);

V1.vy=(lidarPose2.y−lidarPose1.y)/(t2−t1); and

V1.vth=(lidarPose2.theta-lidarPose1.theta)/(t2−t1);

where, lidarPose2.x, lidarPose2.y, and lidarPose2.theta respectively indicates the pose of the lidar of different components on a horizontal plane at the time point t2, lidarPose1.x, lidarPose1.y, and lidarPose1.theta respectively indicates the pose of the lidar of different components on a horizontal plane at the time point t1, and the time point t1 and the time point t2 are adjacent time points.

In one embodiment, if the lidar is a single-line lidar, the calibration data obtaining unit 45 is configured to:

calculate the delay time of the collection time of the raw laser data of point pN with respect to the collection time of the first raw laser data (i.e., the raw laser data of the first point p) in the same frame as the, raw laser data by the following formula:

delayTn1=T*thetaN/360°;

where, delayTn1 is the delay time, T is the time of the lidar to scan for one round, and thetaN is an angle corresponding to the raw laser data of point pN;

calculate a pose difference of pose poseN with respect to pose pose1 by the following formula:

deltaPoseN=poseN−pose1=V1*delayTn1;

where, deltaPoseN is the pose difference (see FIG. 3), poseN is the pose of the lidar when collecting the raw laser data of point pN, and pose1 is the pose of the lidar when collecting the raw laser data of point p1;

transforming the raw laser data (distanceN, thetaN) of point pN from a polar coordinate to a Cartesian coordinate by the following formulas:

pN.x=distanceN*cos(thetaN); and

pN.y=distanceN*sin(thetaN);

transforming the Cartesian coordinate of point pN from a coordinate system of poseN to a coordinate system of pose1 by the following formulas:

pN′.x=deltaPoseN.x+cos(deltaPoseN.theta)*pN.x−sin(deltaPoseN.theta)*pN.y; and

pN′.y=deltaPoseN.y+sin(deltaPoseN.theta)*pN.x+cos(deltaPoseN.theta)*pN.y; and

transforming the Cartesian coordinate in the coordinate system of pose1 to a polar coordinate by the following formulas:

pN′.distance=; and

pN′.theta=tan(pN′.x).

In one embodiment, if the lidar is a multi-line lidar, the lidar pose determining unit 42 includes:

a transformation matrix determining module configured to determine a corresponding transformation matrix based on the transformation relationship between the movable device and the lidar; and

a multi-line lidar pose determining module of the is configured to take a product of the pose of the movable device and the transformation matrix as the pose of the lidar.

In one embodiment, if the lidar is a multi-line lidar, the instantaneous speed determining unit 43 is configured to; obtain a first difference between the pose of the lidar corresponding to the time point t2 and the pose of the lidar corresponding to the time point t1; obtain a second difference between the time point t2 and the time point t1; and take a quotient of the first difference and the second difference as the instantaneous speed matrix of the lidar, where the time point t1 and the time point t2 are two adjacent time points.

In one embodiment, if the lidar is a multi-line lidar, the calibration data determining unit 45 is configured to transform the raw laser data treat a form of polar coordinate to a form of Cartesian coordinate, and obtain the calibration data the raw laser data transformed to the form of Cartesian coordinate by the following formulas:

pM′=pM*(V2*delayTn2)⁻¹, where “−1” indicates the inverse of V2*delay/Tn2; and

delayTn2=T*thetaM/360°;

where, pM is the Mth raw laser data has been transformed to the form of Cartesian coordinate corresponding to the Mth point, pM′ is the calibration data of the Mth raw laser data bas been transformed to the form of Cartesian coordinate, V2 is the instantaneous speed matrix, delayTn2 is the delay time of the collection time of the raw laser data of the Mth point with respect to the collection time of the first raw laser data, T is the time of the lidar to scan for one round, and thetaM is an angle corresponding to the raw laser data of the Mth point.

In one embodiment, the calibration data in a form of the Cartesian coordinate can be converted to a form of a polar coordinate.

It should be understood that, the sequence of the serial number of the steps in the above-mentioned embodiments does not mean the execution order while the execution order of each process should be determined by its function and internal logic, which should not be taken as any limitation to the implementation process of the embodiments.

### Embodiment 3

FIG. 5 is a schematic block diagram of an embodiment of a robot according to the present disclosure. As shown in FIG. 5, in this embodiment, the robot 5 includes a processor 50, a memory 51, a computer program 52 stored in the memory 51 and executable on the processor 50, and a lidar 53. When executing (instructions in) the computer program 52, the processor 50 implements the steps in the above-mentioned embodiments of the laser data calibration method, for example, steps S11-S15 shown in FIG. 2. Alternatively, when the processor 50 executes the (instructions in) computer program 52, the functions of each module unit in the above-mentioned device embodiments, for example, the functions of the units 41-45 shown in FIG. 4 are implemented.

Exemplarily, the computer program 52 may be divided into one or more modules/units, and the one or more modules/units are stored in the storage 51 and executed by the processor 50 to realize the present disclosure. The one or more modules/units may be a series of computer program instruction sections capable of performing a specific function, and the instruction sections are for describing the execution process of the computer program 52 in the robot 5. For example, computer program 52 can be divided into a robot pose obtaining unit, a lidar pose determining unit, an instantaneous speed determining unit, a delay time determining unit, and a calibration data obtaining unit. The functions of each unit are as follows:

the robot pose obtaining unit is configured to obtain a pose of the robot;

the lidar pose determining unit is configured to determine a pose of the lidar 53 based on the pose of the robot and a transformation relationship between the robot and the lidar 53, where the transformation relationship between the robot and the lidar 53 is determined based on an installation position of the lidar 53 on the robot;

the instantaneous speed determining unit is configured to determine an instantaneous speed of the lidar 53 based on the pose of the lidar 53 at two adjacent time points;

the delay time determining unit is configured to determine a delay time of an collection time of one frame of raw laser data obtained through the lidar 53 by scanning for one round with respect to an collection time of a first raw laser data; and

the calibration data obtaining unit is configured to obtain a calibration data of the raw laser data based on the instantaneous speed, the delay time, and the raw laser data.

The robot 5 may include, but is not limited to, a processor 50 and a storage 51. It can be understood by those skilled in the art that FIG. 4 is merely an example of the robot 5 and does not constitute a limitation on the robot 5, and may include more or fewer components than those shown in the figure, or a combination of some components or different components. For example, the robot 5 may further it include an input/output device, a network access device, a bus, and the like.

The processor 50 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 51 may be an internal storage unit of the robot 5, for example, a hard disk or a memory of the robot 5. The storage 51 may also be an external storage device of the robot 5, for example, a plug-in hard disk, a smart media card (SMC), a secure digital (SD) card, flash card, and the like, which is equipped on the robot 5. Furthermore, the storage 51 may further include both an internal storage unit and an external storage device, of the robot 5. The storage 51 is configured to store the computer program 52 and other programs and data required by the robot 5. The storage 51 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated m one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific, application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus robot and method may be implemented in other manners. For example, the above-mentioned apparatus robot embodiment is merely exemplary. For example, the division of modules or limits is merely a logical functional division, and other division manner may be used in actual implementations, that is, multiple units or components may be combined or be integrated into another system, or some of the features may be ignored or not performed.

In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program ma be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented laser data calibration method for a movable device having a lidar, comprising executing on a processor of the movable device the steps of:
obtaining a pose of the movable device;
determining a pose of the lidar based on the pose of the movable, device and a transformation relationship between the movable device and the lidar, wherein the transformation relationship between the movable device and the lidar is determined based on an installation position of the lidar on the movable device;
determining an instantaneous speed of the lidar timed on the pose of the lidar two adjacent time points;
determining a delay time of an collection time of one frame of raw laser data obtained through the lidar by scanning for one round with respect to an collection time of a first raw laser data; and
obtaining a calibration data of the raw laser data based on the instantaneous speed, the delay time, and the raw laser data.

2. The method of claim 1, wherein if the lidar is a single-line lidar, the step of determining the pose of the lidar based on the pose of the movable device and the transformation relationship between the movable device and the lidar comprises:
determining a horizontal position difference {dx, dy, dth} of the lidar with respect to the movable device based on the installation position of the lidar on the movable device; and
determining the pose of the lidar by the following formula:
lidarPose.x=devPose.x+tf.dx;
lidarPose.y=devPose.y+tf.dy:
lidarPose.theta=devPose.theta+tf.dth;
where, lidarPose.x, lidarPose.y, and lidarPose.theta respectively indicates the pose of the lidar of different components on a horizontal plane; devPose.x, devPose.y, and devPose.theta respectively indicates the pose of different components of the movable device on the horizontal plane, and if indicates the transformation relationship between the movable device and the lidar.

3. The method of claim 1, wherein if the lidar is a multi-line lidar, the step of determining the pose of the lidar based on the pose of the movable device and the transformation relationship between the movable device and the lidar comprises:
determining a corresponding transformation matrix based on the transformation relationship between the movable device and the lidar; and
taking a product of the pose of the movable device and the transformation matrix as the pose of the lidar.

4. The method of claim 12, wherein the lidar is a single-line lidar, the instantaneous speed V1 of the lidar includes three components of V1.vx, V1.vy, and V1.vth, the step of determining the instantaneous speed of the lidar based on the pose of the lidar at the two adjacent time points compromises:
determining three components and V1.vx, V1.vy, and V1.vth included in the instantaneous speed V1 by the following formulas:
V1.vx=(lidarPose2.x-lidarPose1,x)/(t2−t1);
V1.vy=(lidarPose2.y-lidarPose1.y)/(t2−t1); and
V1.vth=(lidarPose2.theta-lidarPose1.theta)/(t2−t1);
where, lidarPose2.x, lidarPose2.y, and lidarPose2.theta respectively indicates the pose of the lidar of different components on a horizontal plane at the time point t2, lidarPose1.x, lidarPose1.y, and lidarPose1.theta respectively indicates the pose of the lidar of different components on a horizontal plane at the dime point t1, and the time point t1 and the time point t2 are two adjacent time points.

5. The of claim 3, wherein if the lidar is a multi-lidar, and the instantaneous speed is represented by an instantaneous speed matrix, the step of determining the instantaneous speed of the lidar based on the post of thelidar at the two adjacent time points comprises:
obtaining a first difference between the pose of the lidar corresponding to the time point t2 and the pose of the lidar corresponding to the trot e point t1, wherein the time point t1 and the time point t2 are adjacent time points;
obtaining a second difference between the time point t2 and the time point t1; and
taking a quotient of the first difference and the second difference as the instantaneous speed matrix of the lidar.

6. The method of claim 4, wherein if the lidar is a single-line lidar, the step of obtaining the calibration data of the raw laser data based on the instantaneous speed, the delay time, and the raw laser data comprises:
calculating the delay time of the collection time of the raw laser data of point pN with respect to the collection time of the first raw laser data (i.e., the raw laser data of the first point p1) in the same frame as the raw laser data by the following formula:
delayTn1=T*thetaN/360°;
wherein, delayTn1 is the delay time, T is the time of the lidar to scan for one round, and thetaN is an angle corresponding to the raw laser data of point pN; and
calculating a pose difference of pose poseN with respect to pose pose1 by the following formula:
deltaPoseN=poseN−pose1=V1*delayTn1;
where, deltaPoseN is the pose difference, poseN is the pose of the lidar when collecting the raw laser data of point pN, and pose1 is the pose of the lidar when collecting the raw laser data of point p1;
transforming the raw laser data (distanceN, thetaN) of point pN from a polar coordinate to a Cartesian coordinate by the following formulas:
pN.x=distanceN*cos(thetaN); and
pN.y=distanceN*sin(thetaN);
transforming the Cartesian coordinate of point pN from a coordinate system of poseN to a coordinate system of pose1 by the following formulas:
pN′.x=deltaPoseN.x+cos(deltaPoseN.theta)*pN.x−sin(deltaPoseN.theta)*pN.y;
and
pN′.y=deltaPoseN.y+sin(deltaPoseN.theta)*pN.x+cos(deltaPoseN.theta)*pN.y;
and
transforming the Cartesian coordinate in the coordinate system of pose1 to a polar coordinate by the following formulas:
pN′.distance=; and
pN′.theta=tan(pN′.x).

7. The method of claim 5, wherein if the lidar is a multi-line lidar, the step of obtaining the calibration data of the raw laser data based on the instantaneous speed, the delay time, and the raw laser data comprises:
transforming the raw laser data from a tour of polar coordinate to a form of Cartesian coordinate; and
obtaining the calibration data of the raw laser data transformed to the form of Cartesian coordinate by the following formulas:
pM′=pM*(V2*delayTn2)⁻¹; and
delayTn2=T*thetaM/360°;
where, pM is the Mth raw laser data has been transformed to the form of Cartesian coordinate corresponding to the Mth point, pM′ is the calibration data of the Mth raw laser data has been transformed to the form of Cartesian coordinate, V2 is the instantaneous speed matrix., delayTn2 is the delay time of the collection time of the raw laser data of the Mth point with respect to the collection time of the first raw laser data, T is the time of the lidar to scan for one round, and thetaM is an angle corresponding to the raw laser data of the Mth point.

8. The method of claim 1, wherein the step of obtaining the calibration data of the raw laser data based on the instantaneous speed, the delay time, and the raw laser data comprises:
obtaining the calibration data of the raw laser data based on the instantaneous speed, the delay time, and the raw laser data, and projecting the positions of all the raw laser data obtained in the same frame to the position of the first raw laser data in the same frame.

9. A robot, comprising;
a lidar;
a memory:,
a process; and
one or more computer programs stored in the memory and executable on the processor, wherein the one or more computer programs comprise:
instructions for obtaining a pose of the movable device:
instructions for determining a pose or the lidar based on the pose of the movable device and a transformation relationship between the movable device and the lidar, wherein the transformation relationship between the movable device and the lidar is determined based on an installation position of the lidar on the movable device;
instructions for determining an instantaneous speed of the lidar based on the pose of the lidar at two adjacent time points;
instructions for determining a delay time of an collection time of one frame of raw laser data obtained through the lidar by scanning for one round with respect to an collection time of a first raw laser data; and
instructions for obtaining a calibration data of the raw laser data based on the instantaneous speed, the delay time, and the raw laser data.

10. The robot of claim 9, wherein if the lidar is a single-line lidar, and the instructions for determining the pose of the lidar based on the pose of the movable device and the transformation relationship between the movable device and the lidar comprise:
instructions for determining a horizontal position difference {dy, dy, dth} of the lidar with respect to the movable device based on the installation position of the lidar on the movable device; and
instructions fear determining the pose of the lidar by the following formula:
lidarPose.x=devPose.x+tf.dx;
lidarPose.y=devPose.y +tf.dy;
lidarPose.theta=devPose.theta+tf.dth;
where, lidarPose.x, lidarPose.y and lidarPose.theta respectively indicates the pose of the lidar of different components on a horizontal plane; devPose.x, devPose.y, and devPose.theta respectively indicates the pose of different components of the movable device on the horizontal plane, and tf indicates the transformation relationship between the movable device and the lidar.

11. The robot of claim 9, wherein if the lidar is a multi-line lidar, the instructions for determining the pose of the lidar based on the pose of the movable device and the transformation relationship between the movable device and the lidar comprise:
instructions for determining a corresponding transformation matrix based on the transformation relationship between the movable device and the lidar; and
instructions for taking a product of the pose of the movable device and the transformation matrix as the pose of the lidar.

12. The robot of claim 10, wherein if the lidar is a single-line lidar, the instantaneous speed V1 of the lidar includes three components of V1.vx, V1.vy, and V1.vth, the instructions for determining the instantaneous speed of the lidar based on the pose of the lidar at the two adjacent time points comprise:
instructions for determining three components V1.vx, V1.vy, and V1.vth included in the instantaneous speed V1 by the following formulas:
V1.vx=(lidarPose2.x−lidarPose1.x)/(t2−t1);
V1.vy=(lidarPose2.y−lidarPose1.y)/(t2−t1); and
V1.vth=(lidarPose2.theta-lidarPose1.theta)/(t2−t1);
where, lidarPose1x, lidarPose2,y, and lidarPose2,theta respectively indicates the pose of the lidar of different components on a horizontal plane at the time point t2, lidarPose1 lidarPose1.y, and lidarPose1,theta respectively indicates the pose of the lidar of different components on a horizontal plane at the time point ti, and the time point t1 and the time point t2 are adjacent time points.

13. The robot of claim 11, wherein if the lidar is a multi-line lidar, and the instantaneous speed is represented by an instantaneous speed matrix, the instructions for determining the instantaneous speed of the lidar based on the pose of the lidar at the two adjacent timepoints comprise;
instructions for obtaining a first difference between the pose of the lidar corresponding to the time point t2 and the pose of the lidar corresponding to the time point t1, wherein the time point t1 and the time point t2 are adjacent time points;
instructions for obtaining a second difference between the time point t2 and the time point t1; and
instructions for taking a quotient of the first difference and the second difference as the instantaneous speed matrix of the lidar.

14. The robot of claim 12, wherein if the lidar is a single-line lidar, the instructions for obtaining the calibration data of the raw laser data based on the instantaneous speed, the delay time, and the raw laser data comprise:
instructions forcalculating the delay time of the collection time of the raw laser data of point pN with respect to the collection time of the first raw laser data (i.e., the raw laser data of the first point p1) in the same frame as the raw laser data by the following formula:
delayTn1=T*thetaN/360°;
wherein, delayTn1 l is the delay time, T is the time of the lidar to scan for one round, and thetaN is an angle corresponding to the raw laser data of point pN; and
instructions for calculating a pose difference of pose poseN with respect to pose pose1 by the following formula:
deltaPoseN=poseN−pose1=V1*delayTn1;
where, deltaPoseN is the pose difference, poseN is the pose of the lidar when collecting the raw laser data of point pN, and pose1 is the pose of the lidar when collecting the raw laser data of point p1;
instructions for transforming the raw laser data (distanceN, thetaN) of point pN from a polar coordinate to a Cartesian coordinate by the following formulas:
pN.x=distanceN*cos(thetaN); and
pN.y=distanceN*sin(thetaN);
instructions for transforming the Cartesian coordinate of point pN from a coordinate system of poseN to a coordinate system of pose1 by the following formulas;
pN′.x=deltaPoseN.x+cos(deltaPoseN.theta)*pN.x−sin(deltaPoseN.theta)*pN.y;
and
pN′.y=deltaPoseN.y+sin(deltaPoseN.theta)*pN.x+cos(deltaPoseN.theta)*pN.y;
and
instructions for transforming the Cartesian coordinate in the coordinate system of pose1 to a polar coordinate by the following formulas:
pN′.distance=; and
pN′.theta=tan(pN′.x).

15. The robot of claim 13, wherein if the lidar is a multi-line lidar, the instructions for obtaining the calibration data of the raw laser data based on the instantaneous speed, the delay time, and the raw laser data comprise:
instructions for transforming the raw laser data from a form of polar coordinate to the form of Cartesian coordinate: and
instructions for obtaining the calibration data of the raw laser data transformed to the form of Cartesian coordinate by the following formulas:
pM′=pM*(V2*delayTn2)⁻¹; and
delayTn2=T*thetaM/360°;
where, pM is the Mth raw laser data has been transformed to the form of Cartesian coordinate corresponding to the Mth point, pM′ is the calibration data of the Mth raw laser data has been transformed to the form of Cartesian coordinate, V2 is the instantaneous speed matrix, delayTn2 is the delay time of the collection time of the raw laser data o the Mth point with respect to the collection time of the first raw laser data, T is the time of the lidar to scan for one round, and thetaM is an angle corresponding to the raw laser data of the Mth point.

16. The robot of claim 1, wherein the instructions for obtaining the calibration data of the raw laser data based on the instantaneous speed, the delay time, and the raw laser data comprise:
instructions for obtaining the calibration data of the raw laser data based on the instantaneous speed, the delay time, and the raw laser data, and projecting positions of all the raw laser data obtained in the same frame to the position of the first raw laser data in the same frame.
